(19) United States
(12) Patent Application Publication
(10) Pub. No.: US 2015/0290658 A1
(43) Pub. Date: Oct. 15, 2015

(54) NETWORK OF COMPLEX SYSTEMS FOR ENVIRONMENTAL REMEDIATION, AND METHOD FOR CONTROLLING THE NETWORK

(71) Applicants: Mauro TRIPODI, (US); Paolo TRIPODI, (US); INNOVATION IN SCIENCES & TECHNOLOGIES S.R.L., Roma (IT)

(72) Inventors: Mauro Tripodi, Roma (IT); Paolo Tripodi, Roma (IT)

(73) Assignees: Innovation in Sciences & Technologies S.r.I., Roma (IT); Mauro TRIPODI, Roma (IT); Paolo TRIPODI, Roma (IT); Giuseppe SPANTO, Roma (IT)

(21) Appl. No.: 14/441,105

(22) PCT Filed: Nov. 6, 2013
(86) PCT No.: PCT/IB2013/059953

§ 371 Date: May 6, 2015

Related U.S. Application Data
(60) Provisional application No. 61/722,924, filed on Nov. 6, 2012.

(30) Foreign Application Priority Data
Nov. 6, 2012 (IT) MI2012A001892

(51) Int. Cl. B03C 3/68; G05B 15/02

(52) U.S. Cl. CPC B03C 3/68; G05B 15/02

(57) ABSTRACT

A network for environmental remediation, comprising: one or more complex systems (BAT) adapted for environmental remediation and pollution absorption, temporally correlated and interconnected with a three-dimensional spatial distribution; a Central Operating System (COS) adapted to control the network and said one or more complex systems; the complex systems being structured in one or more clusters, each cluster comprising a complex system as a master and a complex systems as slaves, every Slave reporting to a corresponding Master, and every Master reporting to said Central Operating System.

### FIELD OF THE INVENTION

The present invention relates to a network of complex systems for environmental remediation, and method for controlling the network, and in particular to a dense intensity spatial network of interconnected complex systems for environmental remediation.

### DESCRIPTION OF THE PRIOR ART

Atmospheric pollution is a serious problem requiring a fast solution in the near future, at least for a substantial reduction of global pollution and consequent health and temperature warming side effects.

The main sources of atmospheric pollution are: transport systems (about 40%), residential (about 30%), other sources (30%). Out of these, urban areas where 70% of human beings live are suffering an accumulation of pollution caused by transport and residential living of approximately 57%.

Methodologies for air pollution abatement are well known and deeply studied, and are mainly based on molecular absorption or chemical transformation, namely finding of systems or methods for the reduction of pollution emission or generation.

The strategy of these methods and systems application goes in the direction of solving emissions by capturing it at source or upstream, for example with very expensive up-grade of the industrial plants which incidentally affect only 25% of total pollution source.

The high costs, complex interventions, long interruption of activity and consequential business loss in these industrial plants have resulted in small to no pollution reduction results anywhere in the world.

Transportation produces a densely distributed and mobile emission sources of pollution in a large surface that is the common network of street. Limitation of density (traffic stop) or abatement systems on board have not affected incisively the pollution problem. Residential produces densely distributed emission sources of pollutant in a large volume that is the common network of buildings in towns where people are living and working. At home the kitchen fires are an incredibly intense pollution emission source completely untreated. Thermal boilers are normally used to increase the temperature of water from room temperature to 60° C. for sanitary uses, and for the heating systems. These systems burn gas or gasoline, i.e. fossil fuel. There are no abatement systems for this residential stuff. Habit is to force out the produced pollution in the environment. Therefore at present these ways do not guarantee effectiveness.

### SUMMARY OF THE INVENTION

Therefore it is the main object of the present invention to propose a network of complex systems for environmental remediation, and a method for controlling the network, which overcome the above problems, limitations and drawbacks.

The present invention in particular proposes a network of interconnected complex systems for environmental remediation, temporally correlated and interconnected with a dense three-dimensional spatial distribution, devoted to absorb the pollution present in the atmosphere.

It is a particular object of the present invention a network for environmental remediation, comprising: one or more complex systems adapted for environmental remediation and pollution absorption, temporally correlated and interconnected with a three-dimensional spatial distribution; a Central Operating System adapted to control the network and said one or more complex systems; the complex systems being structured in one or more clusters, each cluster comprising a complex system as a master and a complex systems as slaves, every Slave reporting to a corresponding Master, and every Master reporting to said Central Operating System.

These and further objects are achieved by means of a network of complex systems for environmental remediation, and a method for controlling the network, as described in the attached claims, which form an integral part of the present description.

### BRIEF DESCRIPTION OF THE DRAWINGS

The invention will become fully clear from the following detailed description, given by way of a mere exemplifying and non limiting example, to be read with reference to the attached drawing figures, wherein:

FIG. 1 shows a schematic diagram of the spatial distribution of the network for environmental remediation in accordance with the invention;

FIG. 2 shows a schematic diagram of the hierarchical structure of the network.

The same numeric and lettering references in the figures designate the same or functionally equivalent parts.

### DETAILED DESCRIPTION OF THE PREFERRED EMBODIMENTS

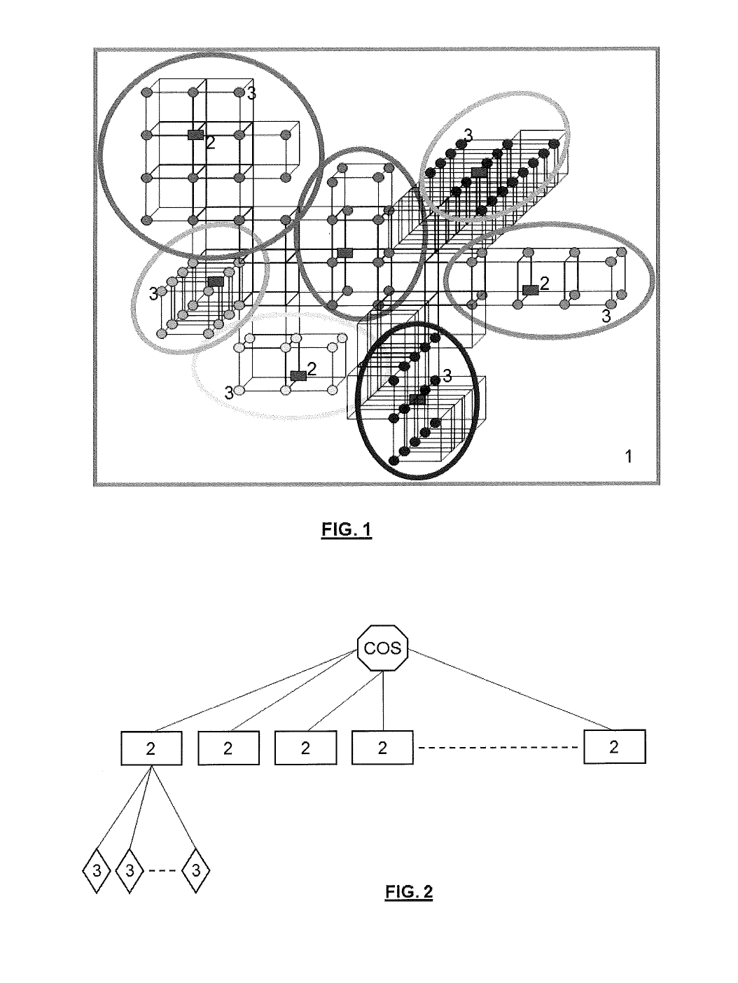

As shown in FIG. 1, the network of the invention shows a structure of interconnected complex systems for environmental remediation, temporally correlated and interconnected with a dense three-dimensional spatial distribution, devoted to absorb the pollution present in the atmosphere.

In particular the present invention addresses anthropic and natural pollution, i.e. pollution that is dangerous for human and natural life cycle health.

The network system develops in a tridimensional spatial structure, not only on a surface (x, y) but even on the third spatial dimension (z). That means the complex systems at the nodes of the network are placed at ground level, as well as underground (for example in the tubes of a metro system), and at elevated levels (for example at upper floors of buildings).

As also shown in FIG. 2, the network is formed by one or more clusters; every cluster is formed by one complex system named Master (2) and a number of complex systems named Slave (3); the number of slaves ranges from 0 to N. Every Slave reports to a corresponding Master, and every Master reports to a Central Operating System (COS). Particularly, the square framework in FIG. 1 represents the network controlled by the COS (1); the tri-dimensional clusters are highlighted by circular or elliptic lines; each cluster comprises a Master (2) and a number of Slaves (3).

The FIG. 1 shows that cluster can be tri-dimensional, bi-dimensional or one-dimensional. The cluster mesh and generally the entire system's mesh is not constant, it means that the distance between one system and the first neighborhood is not constant. A complex system in a node of the network is implemented by a BAT unit, namely a Best Available Technology unit for environment remediation.

The concept of Best Available Techniques (BAT) is well known, for example as defined in the IPPC Directive 96/61/EC for the Protection of the Environment.

BAT is defined as the “most effective and advance stage in the development of an activity and its methods of operation, which indicate the practical suitability of particular techniques for providing, in principle, the basis for emission limit values designed to prevent or eliminate or, where that is not practicable, generally to reduce an emission and its impact on the environment as a whole”, where: ‘best’ in relation to techniques, means the most effective in achieving a high general level of protection of the environment as a whole; ‘available techniques’ means those techniques developed on a scale which allows implementation in the relevant class of activity under economically and technically viable conditions, taking into consideration costs and advantages, whether or not the techniques are used or produced within a single State or several States, as long as they are reasonably accessible to the person carrying out that activity;

‘techniques’ includes both the technology used and the way in which the installation is designed, built, managed, maintained, operated and decommissioned.

A BAT unit absorbs pollution produced that is present in the atmosphere around it; it does not try to reduce the production or generation of pollutants, included into the major pollution generation or concentration areas.

A BAT unit is able to treat an air flow higher than 10 m³/hour.

In a non-limiting example of embodiment, a BAT unit may include an electrostatic precipitator, or electrostatic air cleaner, which is a particulate collection device that removes particles from a flowing gas (such as air) using the force of an induced electrostatic charge. Electrostatic precipitators are highly efficient filtration devices that minimally impede the flow of gases through the device, and can easily remove fine particulate matter such as dust and smoke from the air stream.

The most basic precipitator contains a row of thin vertical wires, and followed by a stack of large flat metal plates oriented vertically. The air or gas stream flows horizontally through the spaces between the wires, and then passes through the stack of plates.

A negative voltage, to produce an intense electric field of several kV/cm, is applied between wire and plate and ionizes the gas around the electrodes. Negative ions flow to the plates and charge the gas-flow particles.

The ionized particles, following the electric field, move to the grounded plates. Particles build up on the collection plates and form a layer. The layer does not collapse, thanks to electrostatic pressure.

A BAT unit may also include a wet scrubber. The wet scrubber describes a variety of devices that remove pollutants from a flue gas or from other gas streams. In a wet scrubber, the polluted gas stream is brought into contact with the scrubbing liquid, by spraying it with the liquid, by forcing it through a pool of liquid, or by some other contact method, so as to remove the pollutants.

The design of wet scrubbers or any gas pollution control device depends on the process conditions and kind of gas pollutants involved. Inlet gas characteristics and dust properties are of primary importance. Scrubbers can be designed to collect particulate matter and/or gaseous pollutants. The versatility of wet scrubbers allows them to be built in numerous configurations, all designed to provide good contact between the liquid and polluted gas stream.

The tridimensional spatial distribution of BAT's depends on the analysis of distribution and density of sources of pollution.

A typical distribution is such that the minimal distance between adjacent complex systems is 2 meters along dimension (z) and 10 meters along dimension (x) or (y).

The dynamic range of network mesh has infrastructural constrains, especially in the vertical direction (dimension z) where the building characteristics force the mesh. In general the mesh is calculated considering a preliminary set of pollution density Cᵢ data. We consider the normal function transformation:

T: [symbol] ⁿ→ [symbol] ^{m}:n>1,m>1

The pollutant concentration Cᵢ is defined as a scalar field:

Cᵢ=C(x,y,z)

Cᵢ, represents the air pollutant like PM₁₀, PM₅, PM_{2,5}, NOₓ, SOₓ, O₃, etc. Considering the target pollutant, we analyze the density and calculate the zero gradient point coordinate (x₀, y₀, z₀):

$$∇ {C}_{i} ( x , y , z ) = \frac{\partial {C}_{i} ( x , y , z )}{\partial x} \hat{i} + \frac{\partial {C}_{i} ( x , y . z )}{\partial y} \hat{j} + \frac{\partial {C}_{i} ( x , y , z )}{\partial z} \hat{k} = 0$$

Depending on the BAT pollution abatement characteristics, the distance Dₕₖ between the neighborhood BAT in the network is calculated in order to reduce the pollutant density in the zero gradient point (x₀, y₀, z₀) below the target threshold:

Dₕₖ:∀(x₀,y₀,z₀):∇Cᵢ(x₀,y₀,z₀)=0 [symbol] Cᵢ(x₀,y₀,z₀)≦C_{threshold}

In urban framework the BAT unit must comply with requirement of acoustic level, legally depending on national laws. Typically the noise produced must be 5% lower in terms of dBA than the average noise level in the surrounding environment.

The network of complex systems is so structured as to be organized in several levels of management and operation.

A) Level for Network Government.
The network is governed centrally by the Central Operating System (COS);
The network has COS-M-S hierarchy;
Every single complex system is controlled, so as to control its level of contribution depending on the degree of measured pollution;
the COS can have a fully centralized structure, or can comprise parts of it located in the Masters.

B) Level for Chemical-Physical-Biological Continuous Environmental Monitoring.

Every single complex system comprises measuring devices able to measure:
environmental parameters like: temperature, pressure, humidity, wind speed and direction;
the density in fluid of carbon oxides, nitrogen oxides, sulphur oxides, ozone, methane, benzene, alcohol, PAH's (polycyclic aromatic hydrocarbons), particulate matter; H₂, H₂S, carbon, oxygen, sulfur, etc;
particulate matter diameter's range.

All the measurements are temporally correlated and consistent, in the sense of equal time frame of measurements. The measures are used also in the level for network government, and can be maintained for statistics and surveillance purposes and communicated to the Central Operating System COS.

The dense environmental parameter monitoring permits to validate the used air quality model and to perform new one on the basis of experimental continuous measurements. C) Level for chemical-physical-biological system control of efficiency of any BAT with possible warning for maintenance.

Every single complex system comprises measuring devices able to measure one or more of the following parameters depending on the internal constitution of the BAT unit:
liquid levels;
air flows;
liquid flows;
working temperatures of air, liquid, BAT electromechanical components;
operation electrical voltages;
operation electrical currents;
overall energy supply of any sort, substance and quantity;
acoustic waves;
optical waves;
RFID signal reading, for operator recognition and enablement, being the operator equipped with a TAG-RFID device.

D) Level for Network Complex Systems Communication;
Every single Slave (S) complex system communicates with its direct Master (M) complex system;
Every single Master (M) complex system communicates with the Central Operating System (COS);
COS controls every single complex system;
the system is organized in cluster;
COS measures all environmental measurements and adaptations, changes or fluctuations thereof on a continuous basis, for example minute-by-minute, based on the measuring signals coming from the complex systems, namely from the masters directly and from the slaves through the masters;
COS stores all the data received by every single complex system including date and time in a database.

E) Level for Network Complex Systems Operations.
Every single complex system is powered by electrical grid or directly stand-alone by renewable energy source. The total energy consumption is generated by renewable energy source.
COS regulates switching-on and switching-off for every single complex system;
COS consequently controls air flows in terms of air in, air out and air throughput of the complex systems;
COS manages the emergency for every single complex system;
COS controls and manages the maintenance procedure and the operators' operations including presence (RFID), audio and video communication;

By means of the present invention, a number of advantages are achieved.

The main advantage is the air pollution abatement inside the network where there are not possibilities to reduce the emission sources. Inside the network the air quality is good independently by the nature and position of emission sources.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the scope of the invention are deemed to be covered by this invention.

The elements and characteristics described in the various forms of preferred embodiments can be mutually combined without departing from the scope of the invention.

Further implementation details will not be described, as the man skilled in the art is able to carry out the invention starting from the teaching of the above description.

In particular, starting from the explanation given above of the functions of the complex systems, the man skilled in the art is able to implement a BAT unit which comprises means for obtaining such functions.

1. A network for environmental remediation, comprising:
one or more complex systems (BAT) adapted for environmental remediation and pollution absorption, temporally correlated and interconnected with a three-dimensional spatial distribution;
a Central Operating System (COS) adapted to control the network and said one or more complex systems;
the complex systems being structured in one or more clusters, each cluster comprising a complex system as a master and a complex systems as slaves, every Slave reporting to a corresponding Master, and every Master reporting to said Central Operating System.

2. The network as in claim 1, wherein a complex system is a Best Available Technology unit (BAT) for environmental remediation, adapted to absorb pollution.

3. The network as in claim 1, wherein a complex system comprises first measuring means adapted to measure:
environmental parameters, temperature, pressure, humidity, wind speed and direction;
density in fluid of one or more of carbon oxides, nitrogen oxides, sulphur oxides, ozone, methane, benzene, alcohol, PAH's (polycyclic aromatic hydrocarbons), particulate matter; H₂, H₂S, carbon, oxygen, sulfur;
particulate matter diameter's range.

4. The network as in claim 1, wherein a complex system comprises second measuring means adapted to measure one or more of the following parameters:
liquid levels; air flows; liquid flows; working temperatures of air, liquid, BAT electromechanical components; operation electrical voltages; operation electrical currents; overall energy supply of any sort, substance and quantity; acoustic waves; optical waves; RFID signal reading.

5. The method for controlling the network for environmental remediation as claim 1, comprising:
communicating by every single Slave (S) complex system with its direct Master (M) complex system;
communicating by every single Master (M) complex system with said Central Operating System (COS);
said Central Operating System (COS) controlling each complex system;
said Central Operating System (COS) measuring environmental measurements and adaptations, changes or fluctuations thereof on a continuous basis, based on measuring signals communicated by the complex systems;
said Central Operating System (COS) storing all the data received by each complex system.
said Central Operating System (COS) analyzing on-line all the data received by each complex system.

6. The method for controlling the network for environmental remediation as in claim 5, wherein said Central Operating System (COS) controlling each complex system comprises:
regulating switching-on and switching-off for each complex system;
controlling air flows in terms of air in, air out and air throughput of the complex systems;
managing the emergency for every single complex system;
controlling maintenance procedures.

7. The network for environmental remediation as in claim 1, wherein said three-dimensional spatial distribution of complex systems (BAT) is determined by calculating the distance Dₕₖ between neighborhood complex systems in order to reduce the pollutant density in the zero gradient point
(x₀, y₀, z₀) below a target threshold C_{threshold}:
Dₕₖ:∀(x₀,y₀,z₀):∇Cᵢ(x₀,y₀,z₀)=0 [symbol] Cᵢ(x₀,y₀,z₀)≦C_{threshold}
wherein the zero gradient point (x₀, y₀, z₀) coordinate derives from
$$∇ {C}_{i} ( x , y , z ) = \frac{\partial {C}_{i} ( x , y , z )}{\partial x} \hat{i} + \frac{\partial {C}_{i} ( x , y . z )}{\partial y} \hat{j} + \frac{\partial {C}_{i} ( x , y , z )}{\partial z} \hat{k} = 0$$
